(19) United States
(12) Patent Application Publication
(10) Pub. No.: US 2016/0018039 A1
(43) Pub. Date: Jan. 21, 2016

(54) Water Distribution and Wastewater Collection Systems for Arctic Environments

(71) Applicant: Anders R. Ekstrand, Anchorage, AK (US)

(72) Inventor: Anders R. Ekstrand, Anchorage, AK (US)

(73) Assignee: Mr. Anders Roland Ekstrand, Anchorage, AK (US)

(21) Appl. No.: 14/332,386

(22) Filed: Jul. 16, 2014

(51) Int. Cl. F16L 53/00

(52) U.S. Cl. CPC F16L 53/002; F16L 53/004

(57) ABSTRACT

The Water Distribution and/or Wastewater Collection System is specifically applicable in permafrost and cold climates in which water and wastewater systems may be subjected to freezing. The Water Distribution and/or Wastewater Collection System is applicable to domestic, industrial, recreational and institutional water distribution and wastewater collection systems including transmission, distribution and collection mains and service connections. The Water Distribution and/or Wastewater Collection System uses an pre-insulated double pipe conduit/casing containing the water and/or wastewater systems and hydronic piping or electric heat tracing. The system design is simple, practical for horizontal directional drilling and economical when compared to conventional permafrost utilidors or insulated and heat traced pipes or deep bury installations, or water bleeding to prevent freezing.

### FIELD OF THE INVENTION

The invention is a system for preventing water distribution and/or wastewater collection mains and services from freezing.

### BACKGROUND OF THE INVENTION

Water Distribution and/or Wastewater Collection Systems in cold climates need to be designed to prevent freezing.

Currently water and wastewater mains and service connections are designed as uninsulated deep bury below the freezing level, insulated deep trenched, or insulated and heat traced in shallower installations in a utilidor below or above ground. Other designs continously bleed water off the water system to the wastewater system or loop the water system to continously maintain flow of water. The current conventional methods are expensive to install and operate, are unreliabile and require extensive maintenance.

The invention eliminates problems associated with the conventional designs outlined above. The pre-insulated casing lends itself to installation by horizontal directional drilling to minimize the cost and environmental impact of installing water distribution and wastewater collection systems. The wastewater collection system shown in this invention can be operated as a vacuum system, pressurized system, gravity system, or a combination of these wastewater collection methods. For smaller water distributions systems or where a looped water distribution system is required to avoid stagnation the hydronic heating can be combined with the domestic water. Larger combined hydronic heating and domestic water distribution systems will be best heated by a boiler on a bypass circuit with a pressure reducer between the intake to the boiler and the discharge from the boiler off the domestic water system main. By setting the pressure reducer to near the pressure loss through the boiler circuit at max flow, this boiler by-pass circuit can maintain a nearly constant flow through the boiler even though the mainline flow varies. By maintaining a constant flow through the boiler, the amount of heat per time imparted to the water distribution system will not vary by mainline flow changes. The temperature inside the pre-insulated casing should be maintained at just above freezing, to avoid defrosting permafrost outside the casing. For the combined hydronic heating and domestic water distribution system, interior pre-insulated casing temperature can be controlled by adjusting the boiler temperature, adjusting the regulator set pressure or turning the mainline pump off and on all of which can be automated. The separate components of the invention are redily available, thoroughly tested and require minimal or no maintenance. The invention is less expensive to install and operate, providing reliability and minimal maintenance of the water distribution and wastewater collection systems in freezing conditions.

The present invention components comprise a pre-insulated polyethelene casing, heat fusible water and/or wastewater piping, electrofusion tapping tees, electrofusion branch saddles, electrofusion couplings, thermal indicators/switches, and a hydronic heating system or a combined hydronic heating looped domestic water system with a boiler bypass circuit. The full water distribution and wastewater collection systems will also require the typical components of these systems which are outside the scope of the invention.

The water distribution and/or wastewater collection systems of this invention are installed by first installing the pre-insulated casing by horizontal directional drilling or trenching. insert the water, wastewater, and hydronic piping into the pre-insulated casing. When the water, wastewater, and hydronic piping mains are installed then cut a hole in the main pre-insulated casing for each service or branch and install pre-insulated casing from the main to the point of connection. Remove the top of the service or branch pre-insulated casing for a length as needed to access the service hole provided in the main pre-insulated casing. Install electrofusion tapping tees or electrofusion branch saddles to the water and/or wastewater mains. Install two electrofusion tees to one of the two hydronic pipes, preferably the outgoing pipe. install a valve or other preset restriction between the two hydronic tees to control hydronic flow to the service or branch. Re-install the top of the service or branch pre-insulated casing (removed to allow access) by heat fusion. Lastly insert the hydronic system thermal indicators/switches, at regular intervals, and control wiring into the pre-insulated casing to assure the system stays above freezing.

### DESCRIPTION OF THE SEVERAL VIEWS OF THE DRAWING

Having thus generally described the invention, it will be referred to more specifically by reference to accompanying drawings illustrating preferred embodiments and in which:

FIG. 1 is an illustration of the pre-insulated casing 1, with water distribution pipe 2, wastewater collection pipe 3, and two hydronic system pipes 4 one outgoing and one return, and thermal indicators/switches with wiring 8;

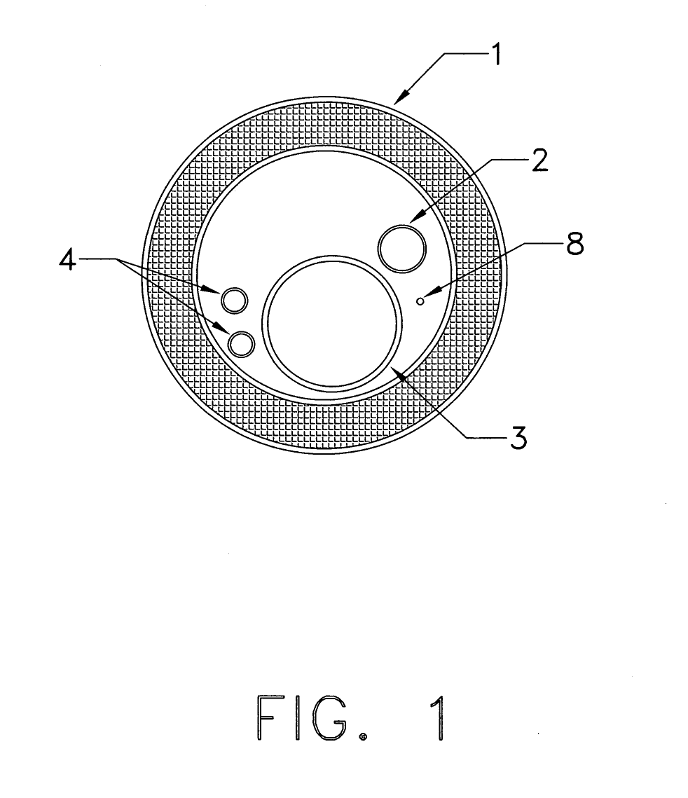

FIG. 2 is an illustration of a water distribution system service or branch only with pre-insulated casing 1, water electrofusion tapping tee connection 4, thermal indicators/switches with wiring 8, automatic valve or preset restriction 9, and hydronic electrofusion tapping tee connections 5;

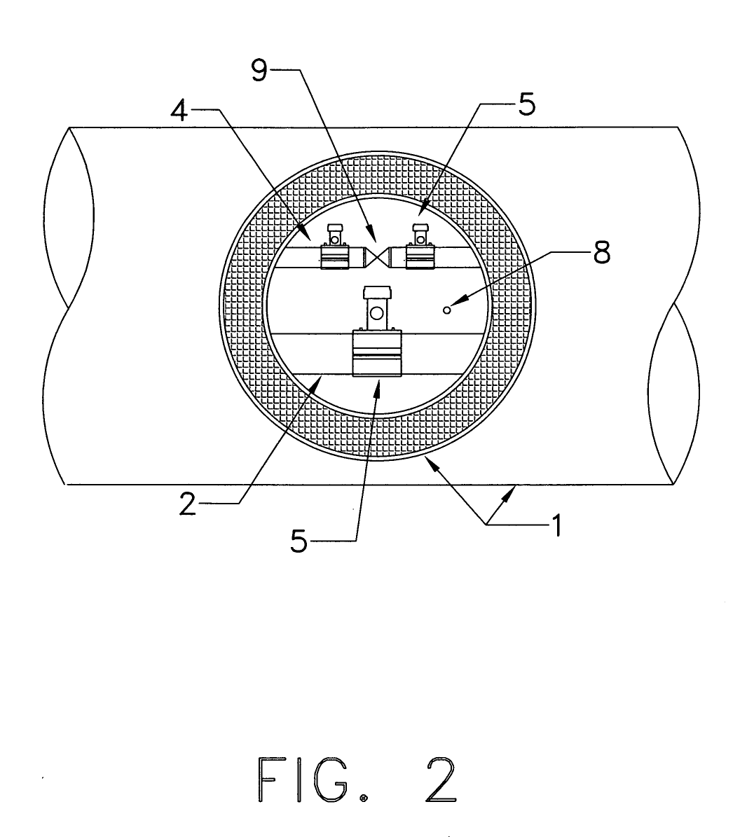

FIG. 3 is an illustration of a wastewater collection system lateral or branch only with pre-insulated casing 1, wastewater electrofusion branch saddle connection 5, thermal indicators/switches with wiring 8, automatic valve or preset restriction 9, and hydronic electrofusion tapping tee connections 4;

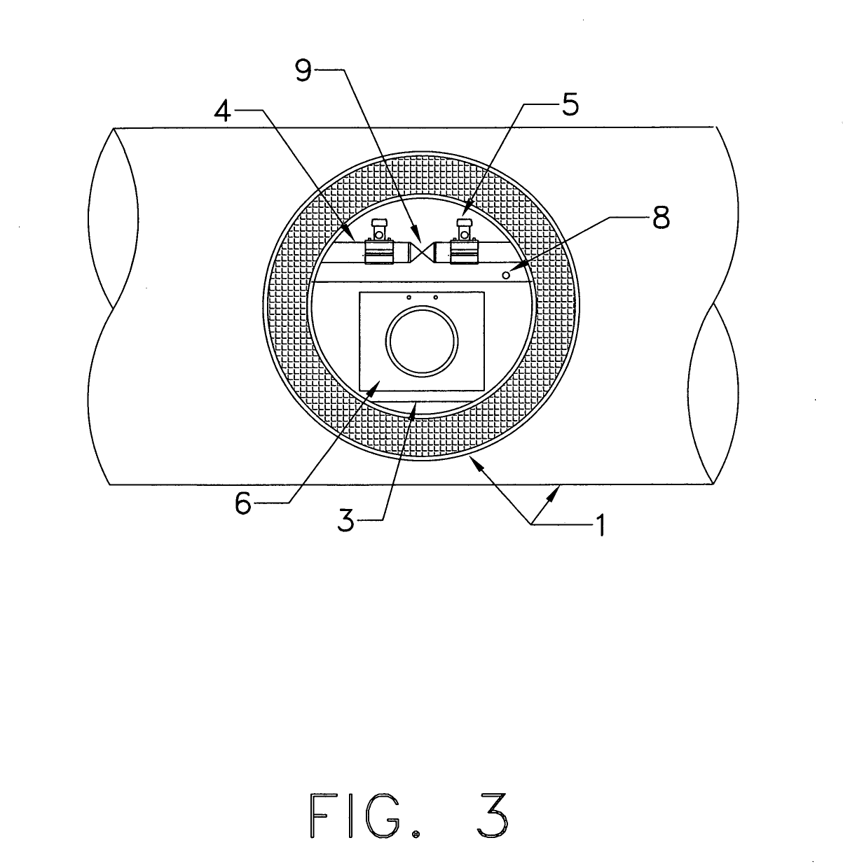

FIG. 4 is an illustration of a water distribution service and wastewater collection system lateral or branch with pre-insulated casing 1, water electrofusion tapping tee connection 4, wastewater electrofusion branch saddle connection 5, thermal indicators/switches with wiring 8, automatic valve or preset restriction 9, and hydronic electrofusion tapping tee connections 4;

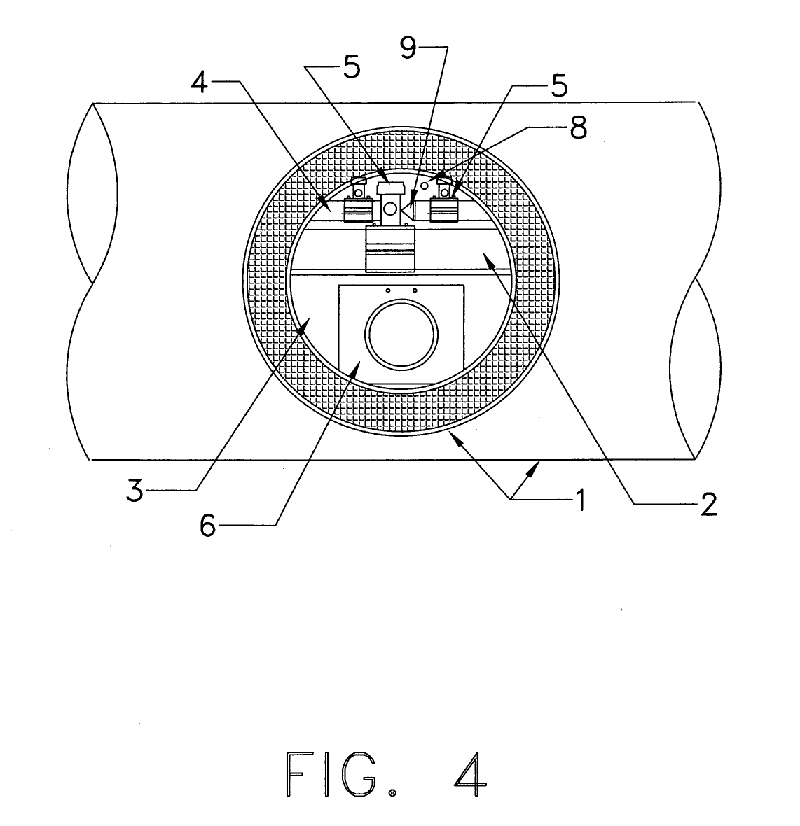

FIG. 5 is a cross-section of a water distribution service and wastewater collection system lateral or branch with pre-insulated casing 1, water electrofusion tapping tee connection 4, wastewater electrofusion branch saddle connection 5, thermal indicators/switches with wiring 8, automatic valve or preset restriction 9, and hydronic electrofusion tapping tee connections 4;

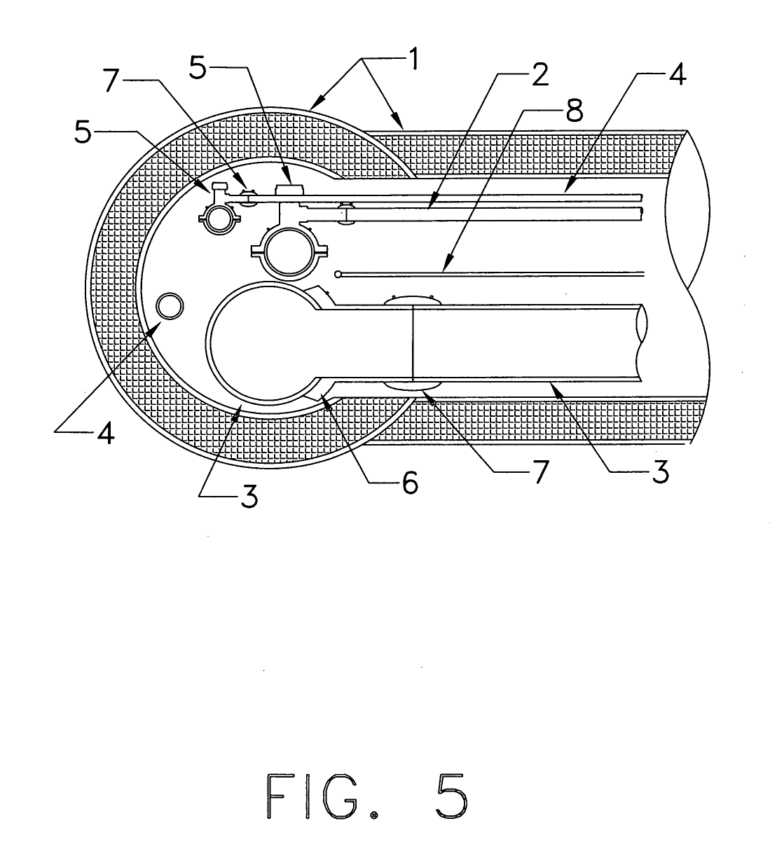

FIG. 6 is an illustration of the pre-insulated casing 1, with a wastewater collection pipe 3, thermal indicators/switches and wiring 8, automatic valve or preset restriction 9, and two combined hydronic and water distribution pipes one outgoing and one return 2;

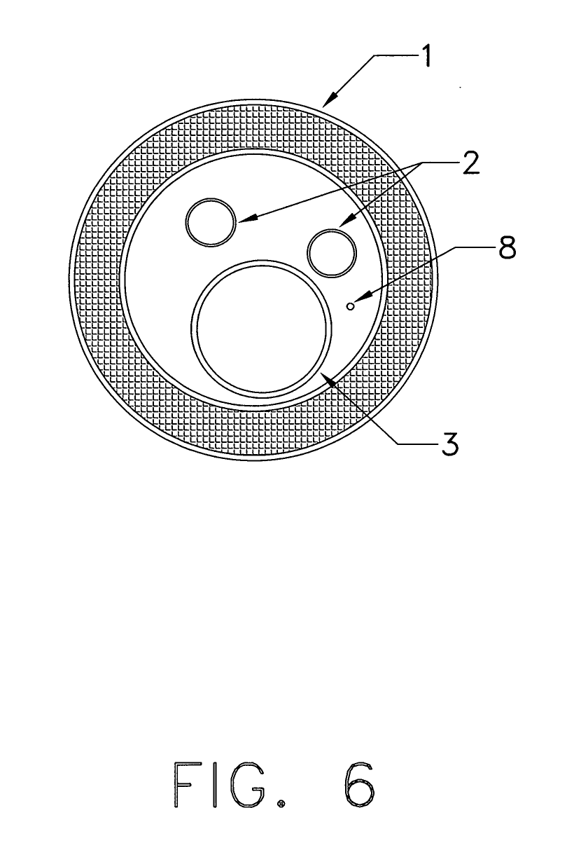

FIG. 7 is an illustration of a water distribution system service or branch only with pre-insulated casing 1, thermal indicators/switches and wiring 8, automatic valve or preset restriction 9, and two combined hydronic and water distribution electrofusion tapping tee connections one outgoing and one return 5;

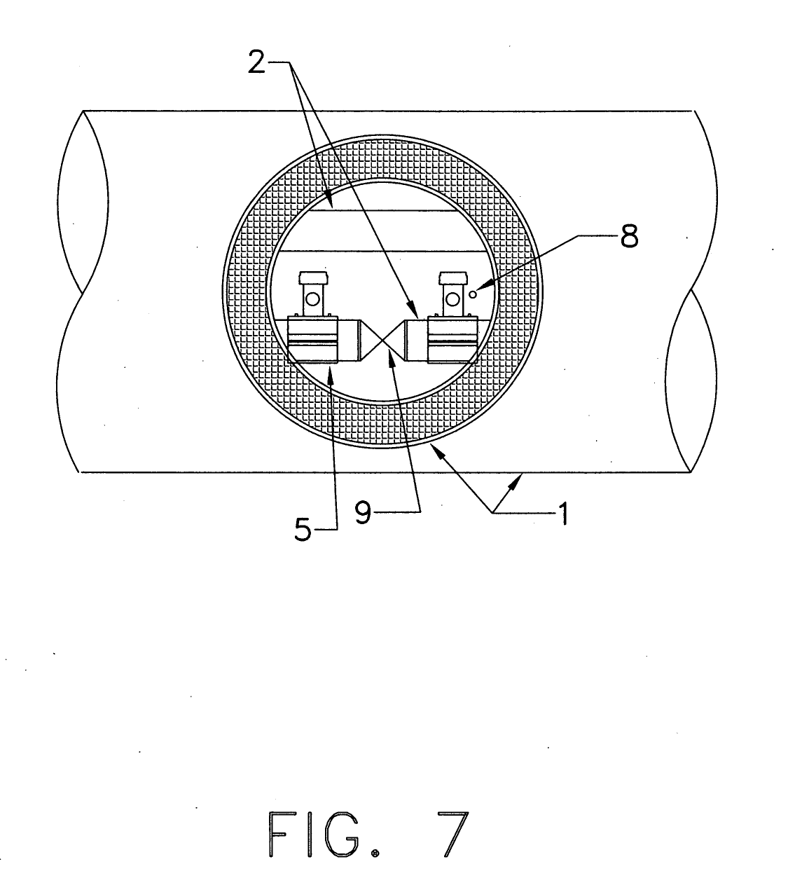

FIG. 8 is an illustration of a water distribution service and wastewater collection system lateral or branch with pre-insulated casing 1, wastewater electrofusion branch saddle connection 5, thermal indicators/switches and wiring 8, automatic valve or preset restriction 9, and two combined hydronic and water distribution electrofusion tapping tee connections one outgoing and one return 5;

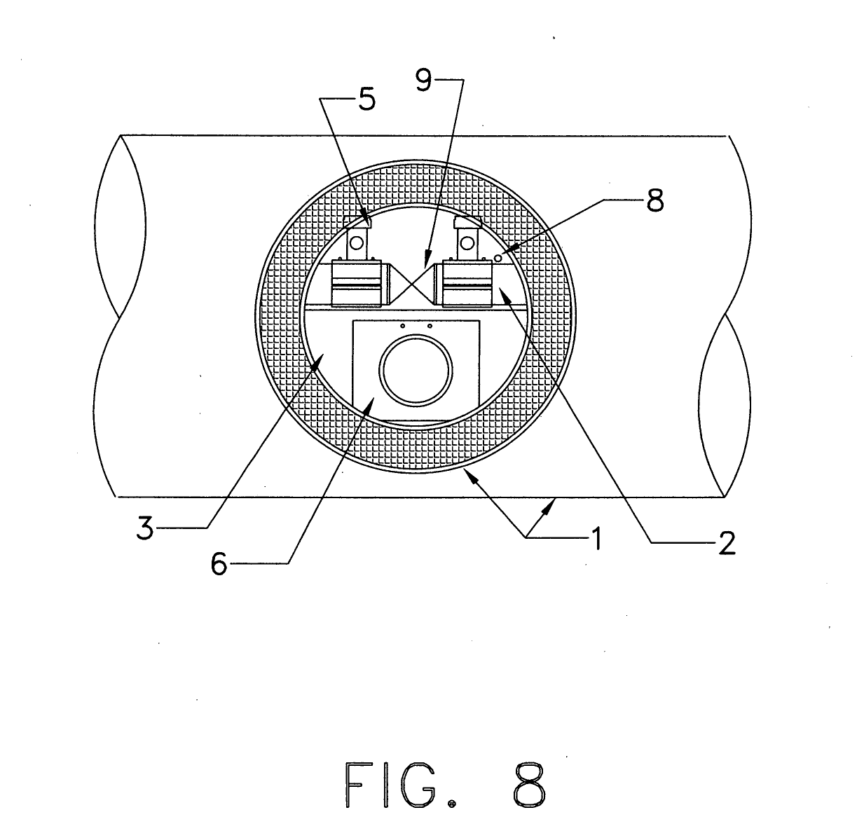

FIG. 9 is a cross-section of a water distribution service and wastewater collection system lateral or branch with pre-insulated casing 1, a wastewater electrofusion branch saddle connection 5, thermal indicators/switches with wiring 8, automatic valve or preset restriction 9, and two combined hydronic and water distribution electrofusion tapping tee connections one outgoing and one return 5.

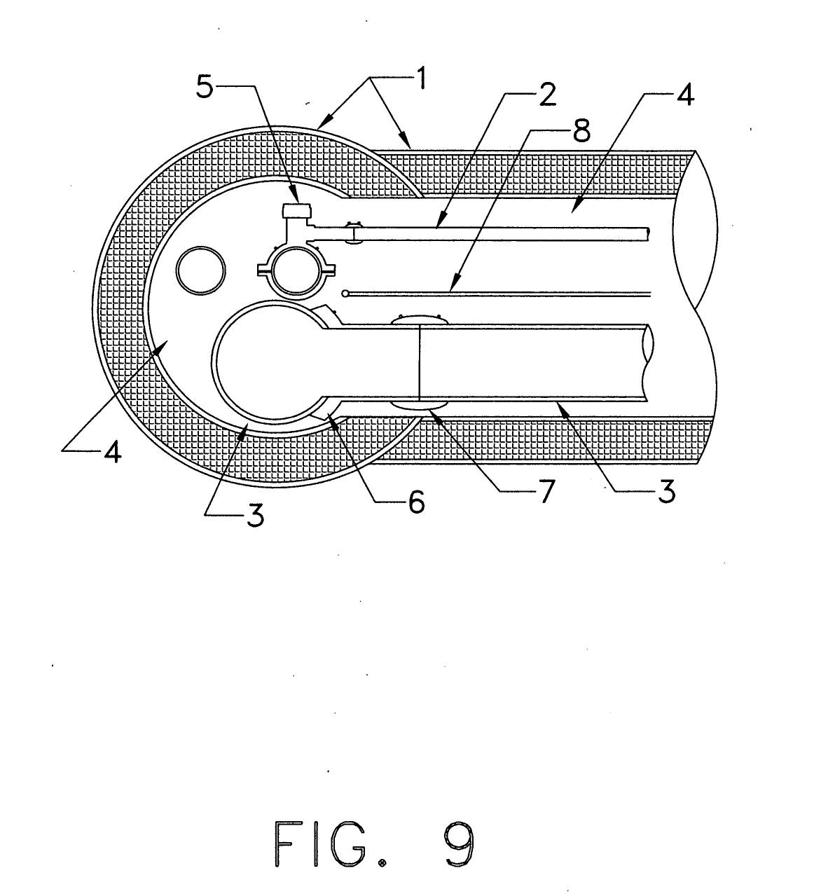

FIG. 10 is a boiler by-pass circuit with a water distribution mainline 2, boiler 10, a pressure reducer 11, and preset restriction 12.

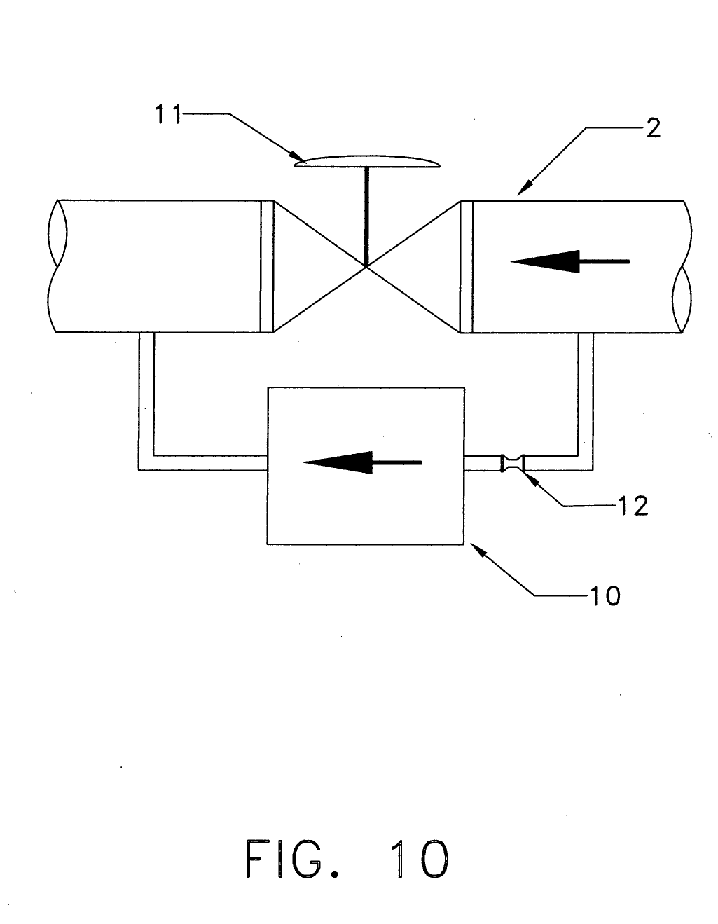

The above description is intended in an illustrative rather than a restrictive sense, and variations to the specific configurations and appurtenances described may be apparent to skilled persons in adapting the present invention to other specific applications. Such variations are intended to form part of the present invention insofar as they are within the spirit and scope of the claims below.

Patent Citations

| Cited | | Publication | | |
|---|---|---|---|---|
| Patent | Filing date | date | Applicant | Title |
| U.S. Pat. No. 3,103,946 | Dec. 14, 1959 | Sep. 17, 1963 | Troxell Monte Evan | System for prevention of pipe |
| | | | | freezing |
| U.S. Pat. No. 6,345,644 | Oct. 31, 2000 | Feb. 12, 2002 | Mcleod Cora | Device for preventing pipeline |
| | | | Marguerite | freezing |
| U.S. Pat. No. 7,089,955 | Jul. 20, 2005 | Aug. 15, 2006 | Komro Sr Grant T | Recreational vehicle low |
| | | | | temperature water supply |
| | | | | warming system |
| U.S. Pat. No. 8,196,602 | Jun. 15, 2009 | Jun. 12, 2012 | Korzeniowski Jan A | Water distribution system for |
| B2 | | | | cold climates |

Classifications

| | |
|---|---|
| U.S. Classification | 138/32 |
| International | E03B7/12 |
| Classification | |
| Cooperative Classification | E03B7/12 |
| European Classification | E03B7/12 |

The invention claimed is:

1. A system for keeping water distribution and/or wastewater collection systems from freezing comprising: pre-insulated polyethylene conduit or casing containing the water and/or wastewater systems and hydronic piping (or electric heat tracing) or combined hydronic and water distribution system;

2. said water distribution and/or wastewater collection system of claim 1 comprises piping for water distribution, wastewater collection and hydronic heating (or trace wire heating system) and temperature indicators/switches which operates the hydronic heating system to maintain the interior of the insulated casing at a pre-set temperature above freezing;

3. the water distribution and/or wastewater collection system of claim 1 wherein pipe connections for services and branches off the water and wastewater mains are made with electrofusion tapping tees, electrofusion saddles or other heat fusion method inside the pre-insulated casing;

4. combined hydronic and water distribution systems of claim 1 with a boiler on a bypass circuit with a pressure reducer between the intake to the boiler and the discharge from the boiler off the domestic water system main. A preset restriction may also be installed to assure the flow through the boiler circuit does not reach destructive velocities. By setting the pressure reducer to near the pressure loss through the boiler circuit at max flow, this boiler by-pass circuit can maintain a nearly constant flow through the boiler even though the mainline flow varies. By maintaining a constant flow through the boiler, the amount of heat per time imparted to the water distribution system will not vary by mainline flow changes.
